(19) United States
(12) Patent Application Publication
(10) Pub. No.: US 2008/0290831 A1
(43) Pub. Date: Nov. 27, 2008

(54) FUEL CELL SYSTEM COMPRISING BATTERY AND METHOD OF CONSUMING RESIDUAL FUEL IN THE FUEL CELL SYSTEM

(75) Inventors: Lei HU, Yongin-si (KR); Young-soo Joung, Anseong-si (KR); Hye-jung Cho, Anyang-si (KR); Young-jae Kim, Seoul (KR); Jae-yong Lee, Seongnam-si (KR); Jin-ho Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/101,418

(22) Filed: Apr. 11, 2008

(30) Foreign Application Priority Data
May 22, 2007 (KR) 2007-49944

(51) Int. Cl. H02J 7/00

(52) U.S. Cl. 320/101

(57) ABSTRACT

A fuel cell system having a back-up battery and a method of consuming residual fuel in the fuel cell system in which the fuel cell system includes a fuel cell, a system controller, a back-up battery, a converter, a fuel supply control, and a driver to drive the fuel supply control, and a charger disposed between the converter and a load. A power output end of the charger is directly connected to the back-up battery via a switch. The converter includes a first converter connected to the back-up battery and a second converter connected to the fuel cell, and the first and second converters are commonly connected to the charger.

### CROSS-REFERENCE TO RELATED PATENT APPLICATION

This application claims the benefit of Korean Patent Application No. 2007-49944, filed May 22, 2007 in the Korean Intellectual Property Office, the disclosure of which is incorporated herein in its entirety by reference.

### BACKGROUND OF THE INVENTION

1. Field of the Invention

Aspects of the present invention relate to an energy generation system to supply power to a load and a method of operating the energy generation system, and more particularly, to a fuel cell system comprising a battery and a method of consuming residual fuel in the fuel cell system.

2. Description of the Related Art

Fuel cell systems are expected to be the next generation energy supply source. A conventional fuel cell system includes a fuel cell in which power is generated; a cartridge in which fuel is stored; a fuel supply apparatus to supply the fuel in the cartridge to the fuel cell; an auxiliary battery; and a control system that controls a process of supplying the fuel, a process of generating power, a process of applying the generated power to a load, and an operation of the auxiliary battery. In such fuel cell system, if there is residual fuel in the fuel cell system when the fuel cell system is separated from a load or when the operation of the fuel cell system is stopped, a cathode potential of the fuel cell may increase due to the residual fuel and the performance of the fuel cell may be greatly decreased. Also, if there is residual fuel in the fuel cell, a catalyst of the fuel cell can be damaged. As a result, the performance of the fuel cell can be decreased.

In order to address problems associated with the residual fuel in the fuel cell system, various methods of consuming the residual fuel have been proposed. One of the methods includes charging a battery using the residual fuel so that the residual fuel is consumed by charging the battery. However, consuming the residual fuel by only charging a battery causes at least the following problems: First, an additional circuit to measure the capacity of the battery is necessary. As a result, the configuration of the fuel cell system is unnecessarily complicated, which makes decreasing the size of the fuel cell system difficult and increases the manufacturing costs. Second, in consideration of the consumption of the residual fuel, the battery must be always maintained at a state of deficient capacity, thus the capacity of the battery for other uses is decreased.

### SUMMARY OF THE INVENTION

To solve the above and/or other problems, aspects of the present invention provide a fuel cell system that does not require an additional apparatus for consuming residual fuel. Aspects of the present invention also provide a method of consuming the residual fuel in the fuel cell system.

According to an aspect of the present invention, there is provided a fuel cell system comprising a fuel cell, a system controller, a back-up battery, a converter unit, a fuel supply control, and a driver that drives the fuel supply control, wherein a charger is disposed between the converter and a load.

According to an aspect of the present invention, a power output end of the charger may be directly connected to the back-up battery via a switch; the converter unit may comprise a first converter and a second converter, wherein the first converter is connected to the back-up battery and the second converter is connected to the fuel cell, and wherein the first and second converters are commonly connected to the charger; and a switch may be installed between the back-up battery and the first converter and between a power output end of the second converter and the charger.

According to an aspect of the present invention, there is provided a method of consuming residual fuel in a fuel cell system, the method comprising: comparing a first power and a second power; wherein the first power is an output power from the fuel cell and the second power is an intrinsic power consumed by the fuel cell system; driving the fuel cell system in a power loss mode if the first power is less than the second power, and determining whether the back-up battery is completely charged if the first power is greater than the second power; wherein, if the first power is greater than the second power, driving the fuel cell system in a valve OFF driving mode if the back-up battery is completely charged, and driving in a charge mode when the back-up battery is not completely charged; wherein during one of the power loss mode, the charge mode, and the valve OFF driving mode, comparing an output voltage from the fuel cell and a set voltage, and when the output voltage from the fuel cell is greater than the set voltage, returning back to the comparison of the first power and the second power.

According to aspects of the invention, when driving the fuel cell system in the charge mode, if the output voltage from the fuel cell is greater than the set voltage and the first power is less than the second power, the fuel cell system may be driven in the power loss mode.

According to aspects of the invention, when the fuel cell system is driven in the power loss mode, while the fuel supply is stopped, the second converter and the charger may be enabled, the first converter may be disabled, and the driver and the back-up battery may be maintained in an inactive state.

According to aspects of the invention, when the fuel cell system is driven in the charge mode, while the fuel supply is stopped, the first converter and the driver may be maintained in an inactive state, the second converter and the charger may be enabled, and a power output end of the charger and the back-up battery may be electrically connected.

According to aspect of the present invention, the method may further comprising, when the fuel cell system is driven in the valve OFF driving mode, while the fuel supply is stopped, enabling the first and second converters, maintaining the driver in an active state, disabling the charger, maintaining the back-up battery in an active state, and applying an OFF driving signal to the driver.

According to aspects of the invention, one of the first and second converters may be firstly enabled.

According to aspects of the invention, after applying the OFF driving signal to the driver, the method may further comprise: driving the fuel cell system in the charge mode to charge the back-up battery; determining whether the output power from the fuel cell reaches a set power; and disabling the first and second converters and the charger if the output power from the fuel cell reaches the set power, and repeating the driving of the fuel cell system in the charge mode if the output power from the fuel cell does not reach the set power.

According to aspects of the invention, after applying the OFF driving signal to the driver, the method may further comprise: disabling the first converter; determining whether the output power from the fuel cell reaches the set power; and disabling the first and second converters and the charger if the output power from the fuel cell reaches the set power, and enabling the charger and electrically connecting the output end of the charger and the back-up battery if the output power from the fuel cell does not reach the set power.

According to aspects of the invention, the fuel supply control may comprise a valve, and the driver may comprise a valve driver; and a switch may be installed each between the back-up battery and the first converter and between the output end of the second converter and the charger.

According to aspects of the present invention, an external device for consuming residual fuel is not necessary and an additional hardware for realizing a method of consuming the residual fuel is unnecessary. Also, the amount of residual fuel in the fuel cell can be minimized by selectively using the three modes for consuming the residual fuel according to the power output conditions of the fuel cell, thereby preventing the fuel cell from reducing performance due to the residual fuel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a fuel cell system having a battery according to an aspect of the present invention;

FIG. 2 is a flow chart showing a method of consuming residual fuel in the fuel cell system of FIG. 1, according to an aspect of the present invention;

FIG. 3 is a block diagram showing the states of elements of the fuel cell system of FIG. 1 operated in a power loss mode to consume residual fuel, according to an aspect of the present invention;

FIG. 4 is a block diagram showing the states of elements of the fuel cell system of FIG. 1 operated in a charging mode to consume residual fuel, according to an aspect of the present invention;

FIG. 5 is a block diagram showing the states of elements of the fuel cell system of FIG. 1 operated in a valve OFF driving mode to consume residual fuel, according to an aspect of the present invention;

FIG. 6 shows pulse driving signals to be applied to a valve driver when the fuel cell system of FIG. 1 is operated in a normal mode supplying power to a load;

FIG. 7 shows an OFF pulse signal to be applied to a valve driver when the fuel cell system of FIG. 1 is operated in a valve OFF driving mode;

FIG. 8 is a flow chart showing a method of consuming residual fuel in the fuel cell system that is operated in a valve OFF driving mode;

FIG. 9 is a diagram simultaneously showing the variation of output power of a fuel cell, the variation of charge level of a back-up battery, and the variation of OFF pulse signal to be applied to a valve driver when the fuel cell system of FIG. 1 is operated in a valve OFF driving mode for consuming residual fuel;

FIG. 10 is a block diagram showing a configuration of a fuel cell system, according to an aspect of the present invention; and

FIGS. 11 through 13 are graphs showing experimental results according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. In addition, when an first element is said to be “disposed between” or “installed between” a second element, the first element can directly connected to the second element, or intervening elements may be disposed or installed therebetween.

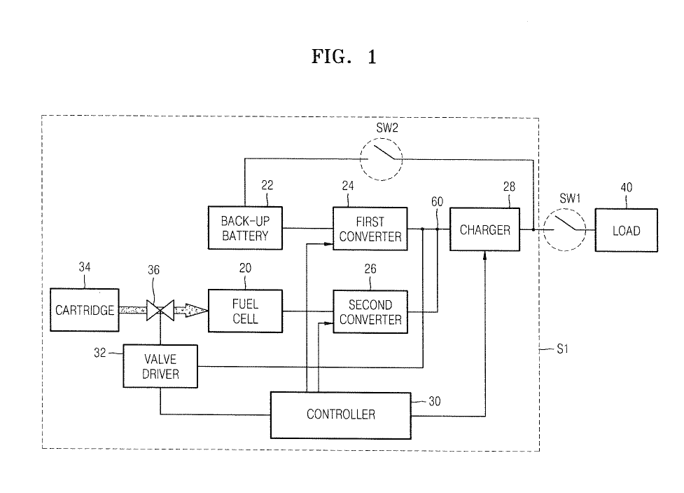

FIG. 1 is a block diagram of a fuel cell system S1 having a battery according to an aspect of the present invention. Referring to FIG. 1, the fuel cell system S1 includes a fuel cell 20, a back-up battery 22, first and second converters 24 and 26, a charger 28, a system controller 30, a valve driver 32, and a fuel cartridge 34. The system controller 30 may be a single-core or multi-core microprocessor, a microcontroller, a single or multi-chip CPU, a system-on-a-chip (SOC), a digital signal processor, a reduced instruction set computer (RISC) microprocessor, an integrated circuit, or any type of logic circuit. A first switch SW1 is disposed between the charger 28 and a load 40 (i.e., a device using the output of the fuel cell system S1). A second switch SW2 is disposed between the charger 28 and the back-up battery 22. The fuel cell 20 can be a monopolar, bipolar, or stack type fuel cell arranged in series and/or parallel and having electrodes arranged in series and/or parallel. The fuel cell 20 receives fuel from the fuel cartridge 34. The fuel cartridge 34 may be a passive type or an active type and may be refillable or detachable from the fuel cell system S1. A valve 36 controls supply of the fuel to the fuel cell 20 and is installed between the fuel cartridge 34 and the fuel cell 20. The valve 36 is an example of a fuel supply control method that controls the supply of fuel to the fuel cell 20 from the fuel cartridge 34. Therefore, the valve 36 is not a limiting control mechanism and may be replaced by another flow controller. A fuel supply apparatus (not shown) may be installed between the fuel cartridge 34 and the fuel cell 20. The driving of the valve 36 is controlled by the valve driver 32. The valve driver 32 is an example of a driving element that may drive a fuel supply flow controller. The valve driver 32 controls the operation of the valve 36 in response to a valve control signal received from the system controller 30. Power required for driving the valve driver 32 can be supplied from the first converter 24, but can also be from the battery 22 or the second converter 20. The second converter 26 connected to the fuel cell 20 may be a DC to DC converter to convert power output from the fuel cell 20 to a stable power suitable for the load 40.

The back-up battery 22, which is connected in parallel with the fuel cell 20, is used for supplying power to the load 40 together with the fuel cell 20. A voltage output from the back-up battery 22 may be smaller than the voltage output from the fuel cell 20 but need not in all aspects. The first converter 24 connected to the back-up battery 22 converts power output from the back-up battery 22 to power suitable for supplying to the load 40. The first and second converters 24 and 26 are connected in parallel and are activated by converter signals received from the system controller 30. The charger 28 is connected to the first and second converters 24 and 26 to adjust power output from the first and second converters 24 and 26 to the load 40 to an acceptable power level as required by the load 40. Also, the charger 28 is used for charging the back-up battery 22 using power generated in the process of consuming residual fuel. The charger 28 is activated by a charge signal received from the system controller 30. Although the fuel cell system S1 is described as depicted in FIG. 1, it is understood that the fuel cell system S1 may include other elements, comprise other constructions, and can be separate from or included in an electronic device having the load 40.

When the first switch SW1 is closed, the second switch SW2 is open and the load 40 is supplied with power from the fuel cell 20. However, during the process of consuming the residual fuel, the first switch SW1 is open, and the second switch SW2 is closed. Thus, power is not supplied to the load 40 during the consumption of the residual fuel, whereas the power is supplied to the back-up battery 22.

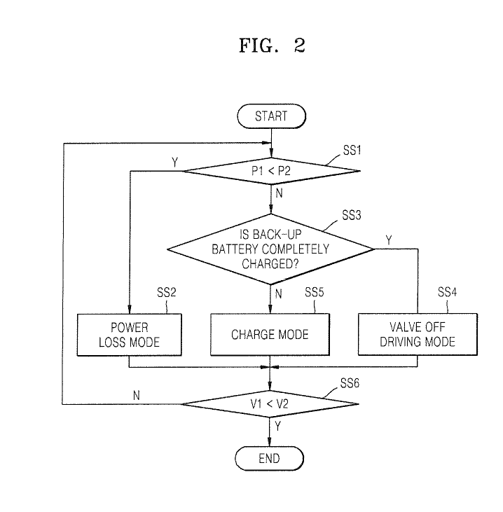

FIG. 2 is a flow chart showing a method of consuming residual fuel in the fuel cell system of FIG. 1, according to an aspect of the present invention. Referring to FIG. 2, the magnitudes of an output power P1 (hereinafter, a first power P1) output from the fuel cell 20 due to the residual fuel and an intrinsic power loss P2 (hereinafter, a second power P2) that is consumed by the constituent elements of the fuel cell system S1 are compared (SS1). Although it is understood that the fuel cell system S1 is not limited to the constituent elements as depicted in FIG. 1, the constituent elements can be, for example, the second converter 26 connected to the fuel cell 20. When the first power P1 is smaller than the second power P2 (SS1-Y), the fuel cell system S1 is operated in a power loss mode (SS2). When the first power P1 is greater than the second power P2 (SS1-N), a charge state of the back-up battery 22 is examined (SS3).

If the back-up battery 22 is completely charged (SS3-Y), the fuel cell system S1 is operated in a valve OFF driving mode (SS4). If the back-up battery 22 is not completely charged (SS3-N), the fuel cell system S1 is operated in a charging mode (SS5).

After the fuel cell system S1 is operated in the power loss mode (SS2), the charging mode (SS5), or the valve OFF driving mode (SS4), the magnitudes of a voltage V1 (hereinafter, a first voltage V1) of the fuel cell 20 and a set voltage V2 (hereinafter, a second voltage V2) are compared (SS6). As a result of comparison in the operation of SS6, if the first voltage V1 is smaller than the second voltage V2 (SS6-Y), the operation of consuming the residual fuel is stopped. However, if the first voltage V1 is greater than the second voltage V2 (SS6-N), the operation of consuming residual fuel is repeated from the operation of SS1.

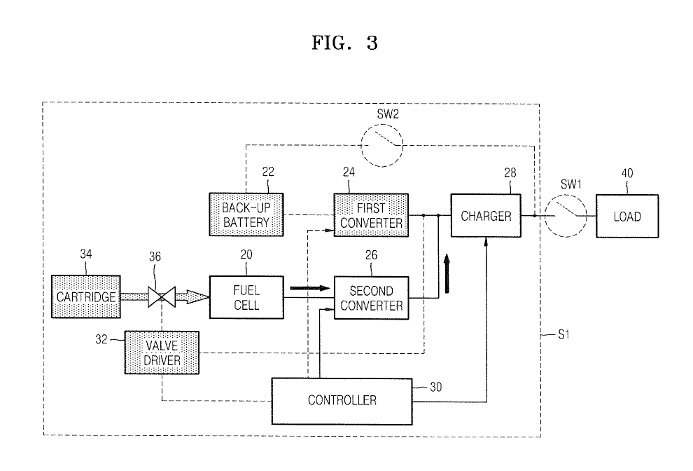

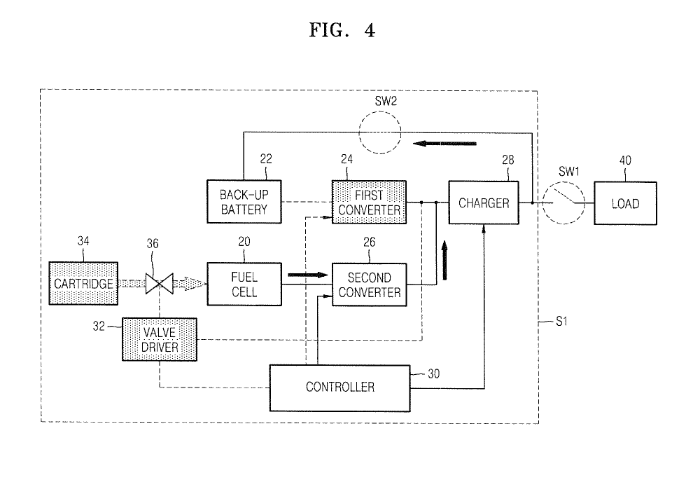

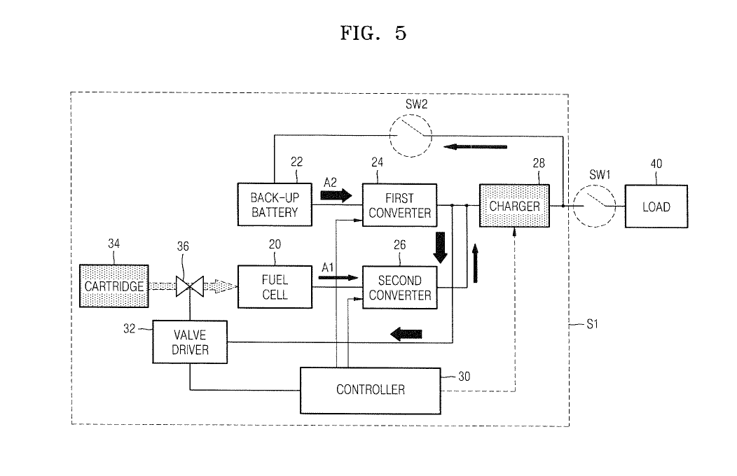

FIG. 3 is a block diagram showing the fuel cell system S1 when the fuel cell system S1 having the battery of FIG. 1 is operated in the power loss mode for consuming residual fuel (operation SS2 from FIG. 2), according to an aspect of the present invention. In FIG. 3, arrows indicate the flow of power generated from the fuel cell 20. Elements that are in an inactive state are shaded for distinguishing; for example, the first converter 24, the cartridge 34, the back-up battery 22, and the valve driver 32 are in an inactive state. Also, among the lines and the control signal lines that connect the constituent elements, the dotted lines indicate that power or control signals are not transmitted through the corresponding line. These line and element indications are also applied in FIG. 4 and FIG. 5.

Referring to FIG. 3, the power generated from the fuel cell 20 flows to the charger 28 through the second converter 26. The second converter 26 is in an active state. That is, the second converter 26 is in an operation state due to a converter signal received from the system controller 30. The power generated from the fuel cell 20 is mostly consumed for the operation of the second converter 26 and the charger 28. The power consumed for the operation of the second converter 26 and the charger 28 can be, for example, approximately 0.1 W. The consumption of the residual fuel is continued until the first voltage V1 of the fuel cell 20 is lower than the second voltage V2. In FIG. 3, elements excluding the fuel cell 20, the second converter 26, the charger 28, and the system controller 30 are in an inactive state, (that is, in a stoppage state). The first and second switches SW1 and SW2 are open.

FIG. 4 is a block diagram showing the fuel cell system S1 when the fuel cell system S1 is operated in the charging mode (operation SS5 from FIG. 2). Referring to FIG. 4, when the fuel cell system S1 is in a charging mode, the first switch SW1 is in an OFF state, and the second switch SW2 is in an ON state. The second converter 26 and the charger 28 are in an active state due to converter and charge signals respectively received from the system controller 30. Thus, the first power P1 generated from the fuel cell 20 due to the residual fuel is supplied to the charger 28 through the second converter 26. The charger 28 charges the back-up battery 22 through the second switch SW2 with the supplied power.

After the back-up battery 22 is completely charged, if the first power P1 generated from the fuel cell 20 is smaller than the second power P2, the fuel cell system S1 is converted to the state as shown in FIG. 3 and is operated in the power loss mode (i.e., the fuel cell system S1 is operated with the first and second switches SW1 and SW2 open). On the other hand, after the back-up battery 22 is completely charged, if the first power P1 generated from the fuel cell 20 is greater than the second power P2 and an output voltage V1 output from the fuel cell 20 is greater than the set voltage V2, the fuel cell system S1 is converted to a state as shown in FIG. 5 and is operated in the valve OFF driving mode (operation SS4 from FIG. 2) to be described hereinafter.

FIG. 5 is a block diagram showing the fuel cell system S1 when the residual fuel is consumed in the valve OFF driving mode (operation SS4 from FIG. 2). In FIG. 5, a first arrow A1 indicates the flow of power generated from the fuel cell 20, and a second arrow A2 indicates the flow of power being supplied to the first converter 24 from the back-up battery 22.

Referring to FIG. 5, the system controller 30, the first and second converters 24 and 26, the back-up battery 22, the valve driver 32, and the fuel cell 20 are in an active state. The charger 28 is in an inactive state, and the first and second switches SW1 and SW2 are in an OFF state. However, the states of the charger 28 and the first converter 24 can vary according to the change of operating conditions during the valve OFF driving mode operation; and also, the second switch SW2 can be in an ON state.

Power generated from the fuel cell 20 during the valve OFF driving mode is consumed for operating the second converter 26 and for applying an OFF signal to the valve driver 32 to operate the valve driver 32 in the OFF driving state. The power consumed for applying an OFF signal to the valve driver 32 is supplied from the back-up battery 22. After an OFF signal is applied to the valve driver 32 using the power of the back-up battery 22, the charge level of the back-up battery 22 is reduced below the completely charged level.

If the charge level of the back-up battery 22 is lower than the completely charged level, the fuel cell system S1 is operated in the battery charge mode (operation SS5 from FIG. 2) by converting the second switch SW2 to an ON state, the first converter 24 to an inactive state, and the charger 28 to an active state (as similarly shown in FIG. 4). Once the back-up battery 22 is completely re-charged, the fuel cell system S1 is converted to the state as shown in FIG. 5 and is operated in the valve OFF driving mode.

The cycle operation between the modes can be continued until the first power P1 is smaller than the second power P2. In the above valve OFF driving mode, if the first power P1 generated from the fuel cell 20 is smaller than the second power P2, the fuel cell system S1 is converted to the state as shown in FIG. 3 and can be operated in the power loss mode (operation SS2 from FIG. 2). The power required to drive the valve driver 32 in the valve OFF drive mode may be approximately 0.5 W.

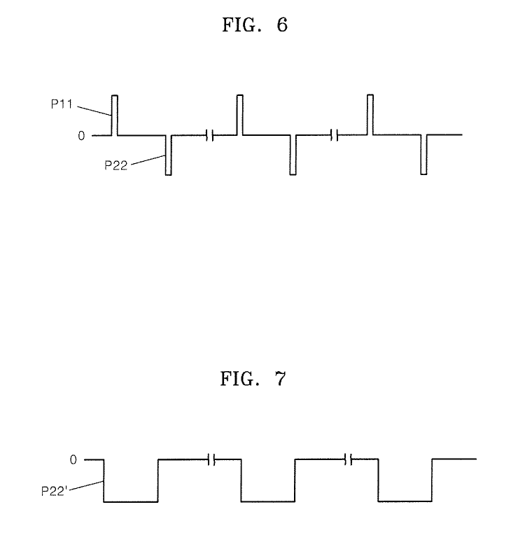

FIG. 6 shows pulse driving signals P11 and P22 to be applied to the valve driver 32 when the fuel cell system having a configuration as illustrated in FIG. 1 is operated in a normal mode (i.e., not in an operation mode for consuming residual fuel). When an ON pulse signal P11 is applied to the valve driver 32, the valve driver 32 opens the valve 36, and when an OFF pulse signal P22 is applied, the valve driver 32 closes the valve 36.

FIG. 7 shows driving signal of a valve driver that only includes an OFF pulse signal P22. The duration of the OFF pulse signal P22 of FIG. 7 is greater than the duration of the OFF pulse signal P22 of FIG. 6. Therefore, the power consumed for applying the OFF pulse signal P22 of FIG. 7 is greater than the power consumed for applying the OFF pulse signal P22 of FIG. 6.

In the valve OFF driving mode depicted in FIG. 5, the OFF driving signal that is applied to the valve driver 32 can be the OFF pulse signal P22 of FIG. 7; however, the OFF driving signal is not limited thereto.

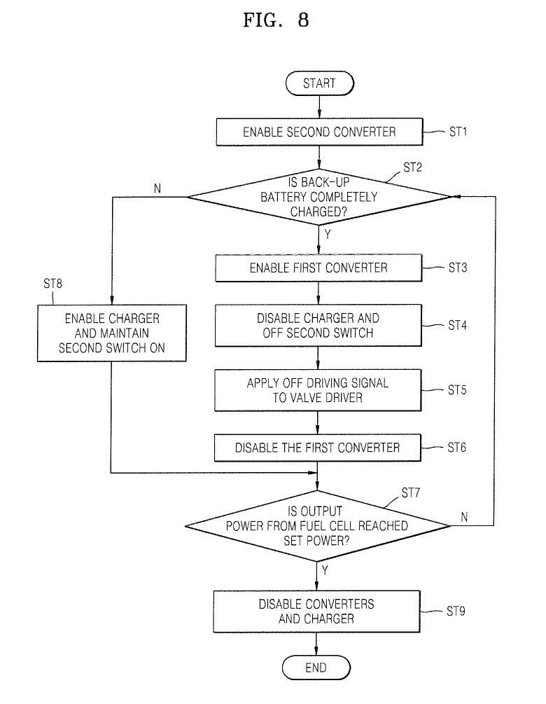

FIG. 8 is a flow chart showing a method of consuming residual fuel in the fuel cell system S1 of FIG. 5 that is operated in the valve OFF driving mode. Referring to FIG. 5 and FIG. 8, the residual fuel consumption operation according to the valve OFF driving mode (operation SS4 from FIG. 2) starts with enabling the second converter 26 (ST1). The converter signal for the second converter 26 is given from the system controller 30.

Next, the charge state of the back-up battery 22 is examined to determine whether the back-up battery 22 is completely charged (ST2). If the back-up battery 22 is completely charged (ST2-Y), an operation of enabling the first converter 24 (ST3), an operation of disabling the charger 28 and turning off the second switch SW2 (ST4), an operation of applying an OFF driving signal to the valve driver 32 for a predetermined time (ST5), and an operation of disabling the first converter 24 (ST6) are sequentially performed. At this point, the time for applying the OFF driving signal to the valve driver 32 can be extended as in FIG. 7 and the time necessary to consume the residual fuel can be reduced.

Next, after the first converter 24 is disabled, a power output from the fuel cell 20 is examined to determine whether the power output from the fuel cell 20 is greater than or equal to the set power (ST7). If the power output from the fuel cell 20 is equal to the set power (ST7-Y), the charger 28 and the first and second converters 24 and 26 are disabled (ST9).

However, if the power output from the fuel cell 20 does not reach the set power (ST7-N), the operation is returned to the operation of ST2 so as to determine the charge state of the back-up battery 22.

In the operation of ST2, if the back-up battery 22 is not completely charged (ST2-N), the charger 28 is enabled and the second switch SW2 is maintained at an ON state (ST8). This state is the same as the charge mode depicted in FIG. 4 corresponding to operation SS5 of FIG. 2.

The disabling of the first converter 24 (operation of ST6) can be performed in the operation of ST8 instead of after the operation of ST5, but need not in all aspects.

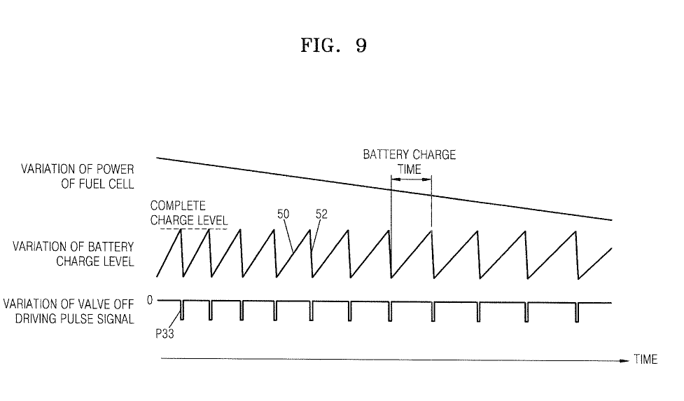

FIG. 9 shows the variation of output power of the fuel cell 20 (an upper line), the variation of charge level of the back-up battery 22 (a middle line), and the variation of OFF pulse signal to be applied to a valve driver 32 (a lower line) when the fuel cell system S1 having a battery of FIG. 1 is operated in a valve OFF driving mode (operation SS4 from FIG. 2).

Referring to FIG. 9, the power output from the fuel cell 20 decreases over time. And, the charge level of the back-up battery 22 varies generally as a saw-tooth waveform, and the period of the waveform increases with the lapse of time (i.e., the frequency of the saw-tooth waveform decreases over time). A ramp-up portion 50 (hereinafter, a first portion 50) selected from the saw-tooth waveform indicates the variation of charge level during charging by the fuel cell 20. Each apex of each saw-tooth of the saw-tooth waveform indicates a point when the back-up battery 22 is completely charged. A drop portion 52 (hereinafter, a second portion 52) which is nearly vertically slanted and is consecutively connected to the first portion 50 of the saw-tooth type indicates rapid reduction of charge level of the back-up battery 22. The variation of the charge level of the back-up battery 22 occurs due to the application of the OFF pulse signal P33 to the valve driver 32, which uses power from the back-up battery 22. Thus, in the variation of the OFF pulse signal, the period of the OFF pulse P33 becomes substantially similar to the period of the charge level.

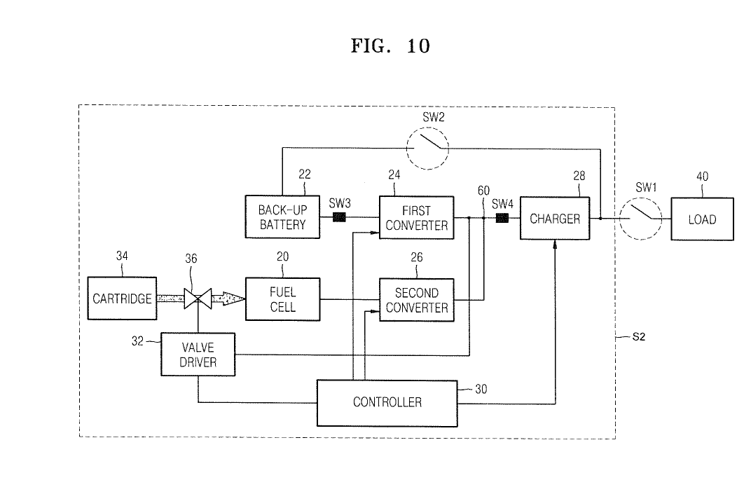

FIG. 10 is a block diagram showing the configuration of a fuel cell system S2 having additional switches compared to the fuel cell system having the battery of FIG. 1, according to another aspect of the present invention. Referring to FIG. 10, a third switch SW3 is disposed between the back-up battery 22 and the first converter 24, and a fourth switch SW4 is disposed between the charger 28 and a contact point 60. The contact point 60 is the point at which the output from the second converter 26 is combined with the output of the first converter 24.

In this example, in the fuel cell system S2 of FIG. 10, the fuel cell system S2 can be operated in the power loss mode (operation S2 of FIG. 2) by maintaining the third and fourth switches SW3 and SW4 in an OFF state and the valve driver 32 and the cartridge 34 in an inactive state. Also, in the fuel cell system S2 of FIG. 10, the fuel cell system S2 can be operated in the charge mode (operation S5 of FIG. 2) by maintaining the third switch SW3 in an OFF state, the second and fourth switches SW2 and SW4 in an ON state, and the valve driver 32 and the cartridge 34 in an inactive state.

Further, in the fuel cell system S2 of FIG. 10, the fuel cell system S2 can be operated in the valve OFF driving mode (operation S4 of FIG. 2) by maintaining the second and fourth switches SW2 and SW4 in an OFF state, the third switch SW3 in an ON state, and the cartridge 34 in an inactive state.

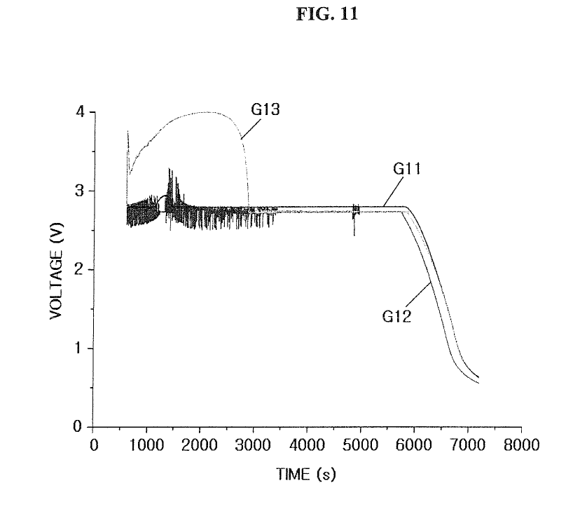

FIGS. 11 through 13 are graphs showing experimental results related to the methods of consuming the residual fuel according to aspects of the present invention. Experiments were performed such that, after methanol was supplied to the fuel cell system S1 of FIG. 1 for 600 seconds, the supply of fuel was stopped. Afterwards, three methods for consuming residual fuel remaining in the fuel cell 20 were used. In the first method (M1), the residual fuel was consumed by applying a constant load of 2.8V to the fuel cell system S1 from the outside. In the second method (M2), the residual fuel was consumed by mixing the three consuming modes (operations SS2, SS5, and SS4 of FIG. 2) according to aspects of the present invention. In the third method (M3), the residual fuel was consumed by using the power loss mode (operation SS4 of FIG. 2). In the graphs of FIGS. 11, 12, and 13, graphs G11, G21, and G31 correspond to the first method M1, i.e., the applying a constant load to the fuel system S1 to consume the residual fuel. In the graphs of FIGS. 11, 12, and 13, graphs G12, G22, and G32 correspond to the second method M2, i.e., the mixing the three consuming modes (operations SS2, SS5, and SS4 of FIG. 2) to consume the residual fuel. In the graphs of FIGS. 11, 12, and 13, graphs G13, G23, and G33 correspond to the first method M3, i.e., the using of the power loss mode (operation SS4 of FIG. 2) to consume the residual fuel.

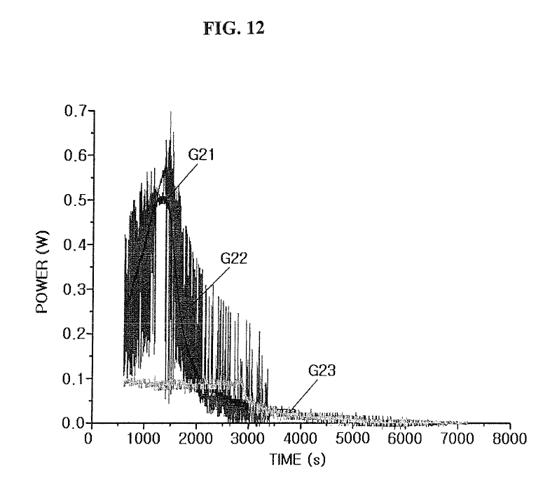

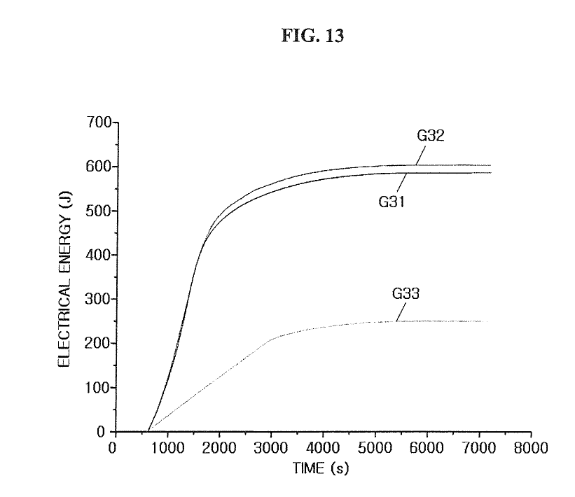

In FIG. 11, first graph through third graph G11, G12, and G13 show voltages of the fuel cell 20 when the residual fuel was consumed using the first through third methods (M1 to M3), respectively. In FIG. 12, first graph through third graph G21, G22, and G23 show power output from the fuel cell 20 when the residual fuel was consumed using the first through third methods (M1 to M3), respectively. In FIG. 13, first graph through third graph G31, G32, and G33 show electrical energy generated when the residual fuel was consumed using the first through third methods (M1 to M3), respectively.

Referring to FIGS. 11 through 13, differences in the voltages of the fuel cell 20 in the above three methods (M1 to M3) with the lapse of time (FIG. 11) are negligible. In the case of the power output (FIG. 12) and the electrical energy (FIG. 13), the first and second methods (M1 and M2) do not show a large differences. However, it is seen that the third method (M3) has a power output (FIG. 12) and electrical energy (FIG. 13) much lower than those of the first and second methods (M1 and M2).

The experimental results as depicted in FIGS. 11 through 13 indicate that, when at least two modes of the three modes of consuming residual fuel according to aspects of the present invention are used in combination, residual fuel consumption is similar to when a load is applied to the fuel cell system S1.

As described above, in the case of a fuel cell system according to an aspect of the present invention, residual fuel in the fuel cell system is consumed to generate power to be used as power for constituent elements included in the fuel cell system or driving the constituent elements, in particular, for driving some of the constituent elements of the fuel supply apparatus. Also, when a charge level of a back-up battery is lower than a completely charged level, the residual fuel is used for charging the back-up battery. While not required, aspects of the invention can be implemented using software and/or firmware used by a computer and/or processor, such as the controller 30.

Therefore, when the fuel cell system according to an aspect of the present invention is used, an external device for consuming the residual fuel is unnecessary. Also, an additional hardware for realizing the residual fuel consuming methods described above is unnecessary. An amount of residual fuel in the fuel cell can be minimized by selectively operating the above-described three modes for consuming the residual fuel according to power output condition of the fuel cell. Therefore, the reduction of fuel cell performance due to the residual fuel can be prevented.

Although a few embodiments of the present invention have been shown and described, it would be appreciated by those skilled in the art that changes may be made in this embodiment without departing from the principles and spirit of the invention, the scope of which is defined in the claims and their equivalents. For example, aspects of the invention may be implemented as software reproducible from a computer readable medium, or implemented as software in a computer, or implemented as a computer, the computer being the controller of the fuel cell system.

What is claimed is:

1. A fuel cell system, comprising:
a fuel cell to supply energy to a load from a fuel;
a back-up battery to supply energy to the load and to store energy from the fuel cell;
a fuel supply control to control a flow of the fuel from a cartridge to the fuel cell;
a driver to drive the fuel supply control according to a control signal;
a charger disposed to charge the back-up battery through the consumption of residual fuel in the fuel cell;
a converter unit to convert power from the fuel cell and the back-up battery and to supply the converted power to the charger and the driver;
a first switch disposed between the charger and the load; and
a system controller to selectively charge the back-up battery and to selectively adjust the control signal to utilize a residual amount of fuel in the fuel cell when the first switch is open.

2. The fuel cell system of claim 1, wherein an output of the charger is directly connected to an input of the back-up battery via a second switch.

3. The fuel cell system of claim 1, wherein the converter unit comprises:
a first converter having an input connected to the back-up battery; and
a second converter having an input connected to the fuel cell,
wherein outputs of the first and second converters are commonly connected to an input of the charger.

4. The fuel cell system of claim 3, wherein a second switch is disposed between the back-up battery and the first converter, and a third switch is disposed between the output of the second converter and the charger.

5. The fuel cell system of claim 3, wherein the first converter supplies power from the back-up battery to the driver, and the second converter converts a power output by the fuel cell to a power suitable for the load.

6. A method of consuming residual fuel in a fuel cell system, the method comprising:
comparing a first power and a second power, the first power being an output power from a fuel cell of the fuel cell system, and the second power being an intrinsic power consumed by the fuel cell system during operation;
driving the fuel cell system in a power loss mode if the first power is less than the second power, the power loss mode being an operation in which the first power is consumed by at least a converter unit and a charger of the fuel cell system;
determining whether a back-up battery of the fuel cell system is completely charged if the first power is greater than the second power;
driving the fuel cell system in a valve OFF driving mode if the back-up battery is determined to be completely charged and the first power is determined greater than the second power, the valve OFF driving mode being an operation in which the converter unit consumes power and an OFF signal is applied to a valve driver of the fuel cell system to consume power from the back-up battery, the valve driver controlling a valve which provides the fuel to the fuel cell;
driving the fuel cell system in a charge mode when the back-up battery is determined to be not completely charged and the first power is greater than the second power, the charge mode being an operation in which the back-up battery is charged to a full charge state;
comparing an output voltage from the fuel cell and a set voltage during one of the power loss mode, the charge mode, and the valve OFF driving mode; and
repeating the comparing of the first power with the second power, the driving the fuel cell system in the power loss mode, the determining whether the back-up battery is completely charged, driving the fuel cell system in the valve OFF driving mode, the driving the fuel cell system in the charge mode, and the comparing the output voltage from the fuel cell and the set voltage if the output voltage from the fuel cell is greater than the set voltage.

7. The method of claim 6, wherein, the driving the fuel cell system in the charge mode comprises changing to the power loss mode if the output voltage from the fuel cell is greater than the set voltage and the first power is less than the second power.

8. The method of claim 6, wherein, the driving the fuel cell system in the power loss mode comprises not supplying a fuel supply to the fuel cell, disabling a first converter of the converter unit, enabling a second converter of the converter unit and a charger, and a driver and the back-up battery are maintained in an inactive state.

9. The method of claim 6, wherein, the driving the fuel cell system in the charge mode comprises not supplying a fuel supply to the fuel cell, a first converter of the converter unit and a driver are maintained in an inactive state, enabling a second converter of the converter unit and a charger, and electrically connecting a power output end of the charger and the back-up battery.

10. The method of claim 6, wherein the driving the fuel cell system in the valve OFF driving mode and not supplying a fuel supply to the fuel cell comprises:
enabling a first converter of the converter unit and a second converter of the converter unit;
maintaining the valve driver in an active state;
disabling the charger;
maintaining the back-up battery in an active state; and
applying an OFF driving signal to the valve driver.

11. The method of claim 10, wherein the first converter is enabled before the second converter is enabled among the first and second converters.

12. The method of claim 10, wherein the second converter is enabled before the first converter is enabled among the first and second converters.

13. The method of claim 10, after applying the OFF driving signal to the driver, the method further comprising:
driving the fuel cell system in the charge mode to charge the back-up battery;
determining whether the output power from the fuel cell reaches a set power; and
disabling the first and second converters and the charger if the output power from the fuel cell reaches the set power, and repeating the driving of the fuel cell system in the charge mode if the output power from the fuel cell does not reach the set power.

14. The method of claim 10, after applying the OFF driving signal to the driver, the method further comprising:
disabling the first converter;
determining whether the output power from the fuel cell reaches a set power; and
disabling the first and second converters and the charger if the output power from the fuel cell reaches the set power, and enabling the charger and electrically connecting a power output end of the charger and the back-up battery if the output power from the fuel cell does not reach the set power.

15. The method of claim 6, wherein a fuel supply control comprises a valve disposed between a fuel cartridge and the fuel cell, and a driver comprises a valve driver.

16. The method of claim 6, wherein a first switch is disposed between a back-up battery and a first converter and a second switch is disposed between the output end of the second converter and the charger.

17. The method of claim 6, while driving the fuel cell system in a valve OFF driving mode, the method further comprising:
enabling a second converter of the converter unit to supply the first power from the fuel cell to the charger;
determining whether the back-up battery is completely charged;
enabling the charger if the back-up battery is determined to be not completely charged so as to supply energy from the charger to the back-up battery;
if the back-up battery is determined to be completely charged, enabling a first converter of the converter unit to supply power to the charger, disabling the charger, applying the OFF control signal to the valve driver, and disabling the first converter; and
determining whether the first power has reached a set power.

18. A computer readable medium comprising instructions that, when executed by a controller of a fuel cell system, cause the fuel cell system to perform the method of claim 6.

19. The method of claim 6, wherein the driving the fuel cell system in a valve OFF driving mode further comprises:
applying valve OFF signals to a valve driver if the back-up battery is completely charged to consume power from the back-up battery.

20. The method of claim 19, wherein, after the power of the back-up battery is consumed by applying valve OFF signals to the valve driver, operating in the charge mode to re-charge the back-up battery.

21. A method of consuming residual fuel in a fuel cell of a fuel cell system, the method comprising:
after removing a load from the fuel cell system, determining whether a first power is less than a second power, the first power being a power output of the fuel cell, and the second power being a power required to operate the fuel cell system;
if the first power is less than the second power, operating the fuel cell system in a power loss mode to consume the residual fuel in the fuel cell;
if the first power is not less than the second power, determining if a back-up battery is completely charged;
if the back-up battery is completely charged and the first power is not less than the second power, operating the fuel cell system in a valve OFF driving mode to consume the residual fuel in the fuel cell by discharging the back-up battery through operation of a fuel cell element; and
if the back-up battery is not completely charged and the first power is not less than the second power, operating the fuel cell system in a charge mode to charge the back-up battery and consume the residual fuel in the fuel cell by charging the back-up battery.

22. The method of claim 21, wherein power of the back-up battery is consumed by apply a valve OFF control signal to a valve driver if the first power is not less than the second power and the back-up battery is determined to be completely charged.

23. A fuel cell system, comprising:
a fuel cell to supply energy to a load from a fuel;
a back-up battery to supply energy to the load; and
a controller to control the fuel cell system to consume residual fuel in the fuel cell by alternately charging the back-up battery and consuming power of the back-up battery through the operation of the fuel cell system.

24. A fuel cell system, comprising:
a fuel cell to supply energy to a load from a fuel;
a back-up battery to supply energy to the load;
a charger disposed between the converter unit and the load to charge the back-up battery;
a valve driver to control a valve through which fuel enters the fuel cell;
a first switch disposed between the load and the charger;
a second switch disposed between the charger and the back-up battery; and
a controller to apply control signals to the charger and the valve driver to consume residual fuel in the fuel cell, after the load is removed from the fuel cell, so that a power of the back-up battery is consumed through the application of a valve OFF signal to the valve driver and the residual fuel is consumed in re-charging the back-up battery.

25. The fuel cell system of claim 23, wherein the controller applies the control signal to consume the residual fuel in the fuel cell if the back-up battery is completely charged.
